(19) United States
(12) Patent Application Publication
(10) Pub. No.: US 2016/0052521 A1
(43) Pub. Date: Feb. 25, 2016

(54) APPARATUS AND METHOD FOR CONTROLLING DISTRIBUTION OF BRAKING FORCE OF VEHICLE

(71) Applicant: Hyundai Motor Company, Seoul (KR)

(72) Inventors: Woo Cheol Cho, Daejeon (KR); Deok Keun Shin, Yongin (KR)

(21) Appl. No.: 14/569,719

(22) Filed: Dec. 14, 2014

(30) Foreign Application Priority Data
Aug. 19, 2014 (KR) 10-2014-0107551

(51) Int. Cl. B60W 30/18; B60W 10/184; B60W 10/08

(52) U.S. Cl. CPC B60W 30/18127; B60W 10/08; B60W 10/184

(57) ABSTRACT

A method and an apparatus are provided for distributing a braking force to braking units upon braking of an eco-friendly vehicle equipped with a motor. The distribution of a braking force of a vehicle includes a creep torque to calculate a total braking force and distribute the total braking force to each braking unit to provide a more uniform braking force based on a vehicle speed.

### CROSS-REFERENCE TO RELATED APPLICATION

This application claims under 35 U.S.C. §119(a) the benefit of Korean Patent Application No. 10-2014-0107551 filed Aug. 19, 2014, the entire contents of which are incorporated herein by reference.

### BACKGROUND

(a) Technical Field

The present invention relates to an apparatus and a method for controlling a distribution of a braking force of a vehicle upon braking of an eco-friendly vehicle. More particularly, the present invention relates to an apparatus and a method for maintaining and distributing a uniform total braking force based on a brake pedal input.

(b) Background Art

When a vehicle equipped with a motor brakes, braking is performed by a cooperation between a frictional braking unit and a motor. In other words, a braking force is exerted based on a brake pedal depth (e.g., a depth of pedal engagement) through regenerative braking together with frictional braking. Thus, a brake demand (braking force) by a driver is determined by the brake pedal depth and is divided into the frictional braking and regenerative braking. When a vehicle stops, a substantially uniform torque is input in a traveling direction of a vehicle, and when braking is performed during a driving of a vehicle, a substantially uniform torque is input in the opposite direction to the traveling direction of a vehicle, which is called a creep torque (including a costregen torque). However, since such creep torque is not considered, a deviation occurs in the braking force.

Accordingly, even when a driver demands a uniform braking force by engaging (e.g., exerting pressure onto) a brake pedal by a substantially uniform depth, the creep torque is changed based on a reduction of the vehicle speed and thus, the braking force is changed. Accordingly, there is a limitation in that a driver feels a sense of difference when performing braking since different braking forces are delivered based on the reduction of the vehicle speed. A static creep torque is converted from a backward torque to a bidirectional torque, which causes a driver to have a feeling of being pushed just before the vehicle stops (e.g., a jerk sensation). Additionally, for such reasons, due to an interruption (e.g., gear shift from drive (D) to neutral (N) or breakdown of a motor or an inverter) of the regenerative braking during the braking or a creep torque (including costregen torque) during the gear shift, a feeling of thrust or abruptness may occur.

FIG. 1 illustrates an exemplary total braking force varying according to a vehicle speed in a related art. In a related art, a creep torque is not considered when a braking force is calculated. Accordingly, since a torque applied to a motor varies according to the vehicle speed despite an input of a substantially uniform brake pedal depth by a driver, a uniform sense of deceleration cannot be maintained.

In particular, the related art discloses a method of controlling an electric vehicle, which can minimize an irregular change of deceleration upon braking. The method relates to a hybrid electric vehicle using an engine and a motor driven by a battery as power sources and includes determining whether the electric vehicle is in a braking state, decreasing a creep torque output from the motor to a reference value or less when the electric vehicle is in the braking state, performing a regenerative braking operation of the electric vehicle by a regenerative braking force when the creep torque is decreased to the reference value or less, and restoring the creep torque to a predetermined value by speed section when the regenerative braking operation is finished. Accordingly, the related art provides a technology that minimizes a change of deceleration by the creep torque. However, a sense of difference in driving may not be overcome while applying a creep torque according to the speed of a vehicle. In addition, there is no effect of the fuel efficiency improvement through the creep torque.

The above information disclosed in this section is merely for enhancement of understanding of the background of the invention and therefore it may contain information that does not form the prior art that is already known in this country to a person of ordinary skill in the art.

### SUMMARY

The present invention provides a method for controlling a distribution of a braking force of a vehicle, which maintains a more uniform total braking force, by summing a braking force based on a brake pedal depth and a creep torque during braking to measure the total braking force and distributing the braking force according to the total braking force calculated for the braking.

In one aspect, the present invention provides a method for controlling a distribution of a braking force of a vehicle that may include: measuring a creep torque at a point of braking (e.g., when braking commences); calculating a total braking force by summing the measured creep torque and a braking force generated based on a brake pedal depth while fixing the measured creep torque; and distributing the total braking force to a regenerative braking force and a frictional braking force.

In an exemplary embodiment, the distributing of the total braking force may further include: determining whether a brake input signal is finished, after the distributing of the total braking force; and stopping braking by a braking unit and setting a creep torque according to a current vehicle speed when the brake input signal is finished, and measuring the creep torque at the point of braking when the brake input signal is not finished. In addition, the calculating of the total braking force may include maintaining the total braking force at a substantially uniform value upon performance of braking by summing the braking force generated based on the brake pedal depth and the measured creep torque.

In another aspect, the present invention provides an apparatus for controlling a distribution of a braking force of a vehicle that may include: a sensing unit (e.g., a sensor) configured to detect a brake input signal and measure a brake pedal depth (e.g., an engagement depth); a frictional braking unit configured to perform frictional braking; a regenerative braking unit configured to perform regenerative braking; and a controller configured to distribute a braking force, calculate a total braking force by adding a creep torque measured at a point of braking to a braking force based on the brake pedal depth while fixing the measured creep torque, and distribute the total braking force to each braking unit.

In an exemplary embodiment, the total braking force of the braking units calculated by the controller, may be calculated by summing a substantially uniform braking force generated based on the brake pedal depth and the measured creep torque, and may have a substantially uniform value upon braking. In addition, the controller may include a brake controller, a vehicle controller, a motor controller, and a transmission controller.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view illustrating a variation of a braking force shown by a creep torque after a distribution of the braking force of a braking device according to a related art;

FIG. 2 is an exemplary view illustrating an apparatus for controlling a distribution of a braking force of a vehicle according to an exemplary embodiment of the present invention;

FIG. 3 is an exemplary flowchart illustrating a method for controlling a distribution of a braking force of a vehicle according to an exemplary embodiment of the present invention; and

FIG. 4 is an exemplary view illustrating a braking force maintained at a substantially uniform value regardless of a vehicle speed through a method and an apparatus for controlling a distribution of the braking force of a vehicle according to an exemplary embodiment of the present invention.

Reference numerals set forth in the Drawings includes reference to the following elements as further discussed below:
100: apparatus for controlling distribution of braking force of vehicle
101: controller
102: frictional braking unit
103: regenerative braking unit
104: sensing unit

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings so that those skilled in the art can easily carry out the present invention.

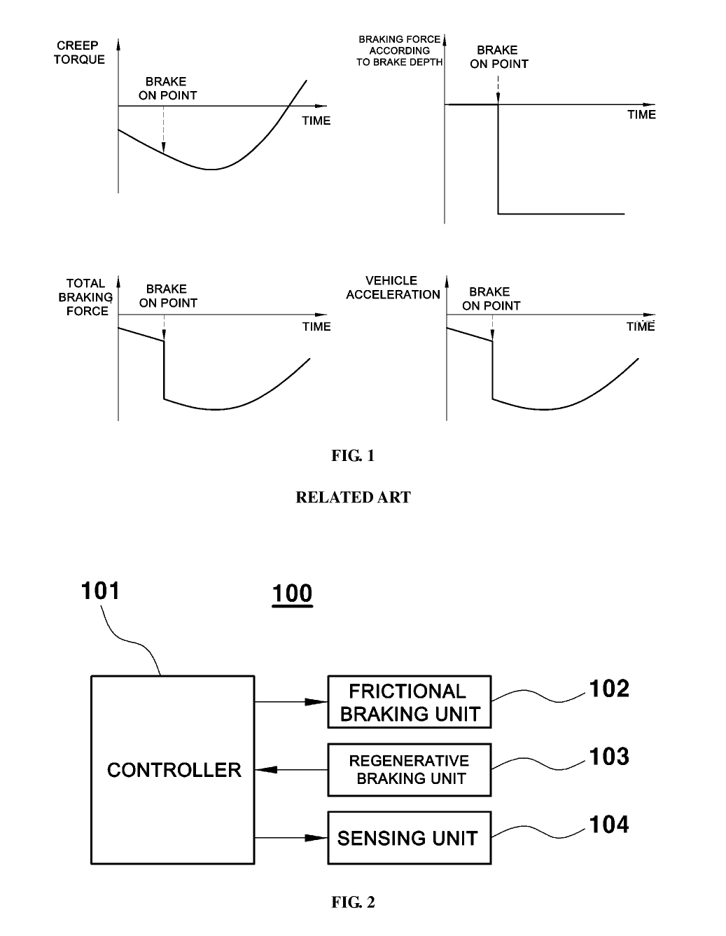

FIG. 2 is an exemplary view illustrating an apparatus 100 for controlling a distribution of a braking force of a vehicle according to an exemplary embodiment of the present invention. Referring to FIG. 2, the apparatus 100 may include a controller 101, a frictional braking unit 102, a regenerative braking unit 103, and a sensing unit 104. The controller 101 may be configured to operate the frictional braking unit 102, the regenerative braking unit 103, and the sensing unit 104 (e.g., the sensor). In addition, the controller 101 may be configured to calculate a brake pedal depth (e.g., a depth of engagement of the brake pedal) and a creep torque upon input of a brake, calculate a total braking force in which the creep torque upon braking is added to a braking force demanded by the brake pedal depth, and distribute the braking force to each braking unit based on the total braking force. The frictional braking unit 102 may be configured to provide a frictional braking force, the regenerative braking unit 103 may be configured to perform regenerative braking, and the sensing unit 104 may be configured to measure the brake pedal depth.

The sensing unit 104 may include a Brake Position Sensor (BPS) configured to measure the brake pedal depth. The BPS may be configured to measure a brake pedal input signal of a driver, and measure the depth of the brake pedal. The controller 101 may include a brake controller, a vehicle controller, a motor controller, and a transmission controller. The brake controller may be configured to operate the total braking force, and distribute the braking force to the braking units based on the regenerative braking execution of the vehicle controller. The vehicle controller may be configured to determine the regenerative braking execution based on the regeneration forbidding situation. The motor controller may be configured to execute the regenerative braking of the regenerative braking unit based on a regenerative braking execution command. The transmission controller may be disposed within a vehicle and may include a multi-stage transmission to deliver information regarding a transmission state to the vehicle controller.

Furthermore, the controller 101 may be configured to detect the applied brake pedal input signal from the sensing unit, calculate a braking force based on the brake input depth, and measure the creep torque based on the vehicle speed upon brake input. The total braking force may include the braking force demanded based on the brake pedal depth and the creep torque based on the vehicle speed upon brake input calculated by the controller.

According to the calculated total braking force, the controller 101 may be configured to apply the braking force to each braking unit. Thus, the calculated total braking force may be calculated by summing the braking force based on the brake pedal depth and the fixed creep torque measured upon braking, and may have a substantially uniform value. In other words, the total braking force may be calculated by including the creep torque upon braking without being affected by the creep torque varying with the vehicle speed, and the braking force may be distributed to the braking units based on the total braking force. Accordingly, a more uniform braking force and acceleration may be provided regardless of the vehicle speed when a brake input signal occurs.

In one exemplary embodiment, a method for controlling a distribution of a braking force of a vehicle according to a regenerative braking forbidding situation is disclosed. In the regenerative braking forbidding situation, the regenerative braking forbidding situation may be determined using the vehicle controller. In particular, the regenerative braking forbidding situation may include when the stage of the transmission is changed into neutral-stage or when a driving motor or a motor inverter malfunctions. The controller 101 may be configured to distribute the total braking force to the frictional braking unit when the regenerative braking unit is not operated. However, in a related art, the braking force may be distributed to the braking units based on the brake input signal without summing up or considering the creep torque. As a result, there is a limitation in the related art in that a feeling of being pushed may occur by the magnitude of a costregen torque in the regenerative braking forbidding situation. The creep torque may include the costregen torque occurring upon braking.

However, according to an exemplary embodiment, the braking force based on the brake input signal and the creep torque based on the vehicle speed upon brake input may be measured. Thus, the calculated total braking force may be calculated by summing the braking force demanded based on the brake pedal depth and the fixed creep torque based on the vehicle speed upon brake input. Even when the total braking force is applied to the frictional braking unit when the regenerative braking unit is not operated, the braking force including the costregen torque may be distributed, thus preventing an occurrence of the feeling of being pushed upon braking of a vehicle (e.g., a jerk feeling). In the regenerative braking forbidding situation, the braking force applied to the frictional braking unit may be set to about the same magnitude as the calculated total braking force. In other words, the braking force distributed to the frictional braking unit by the controller may be the total braking force including the creep torque upon braking and the braking force occurring based on the brake pedal depth.

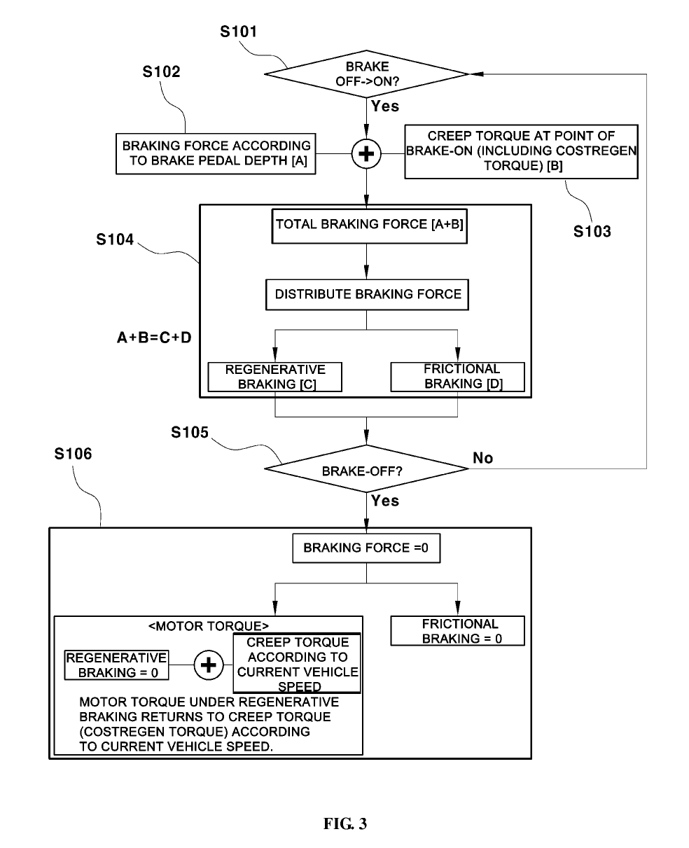

FIG. 3 is an exemplary flowchart illustrating a method for controlling a distribution of a braking force of a vehicle according to an exemplary embodiment of the present invention. When a brake input signal is applied based on a braking demand of a driver during the driving of a vehicle (S101), a substantially uniform braking force may be provided. Accordingly, a creep torque may be calculated at the point of braking (S103), and a braking force based on a brake pedal depth may be measured (S102). A total braking force necessary for the braking of a vehicle may be calculated by summing the creep torque measured upon braking and the braking force occurring based on the brake pedal depth. The calculated total braking force may be distributed to braking units including a regenerative braking unit and a frictional braking unit (S104). In an eco-friendly vehicle, the braking units may include the frictional braking unit and the regenerative braking unit.

After the braking force is applied to the braking units based on the total braking force calculated to perform braking, whether the brake input signal is finished may be determined by the controller (S105). When the brake input signal is complete, the braking by the braking units may be stopped, and the creep torque may be set based on a current vehicle speed. When the brake input signal is not complete, the initial process may be repeated based on the brake input signal (S106).

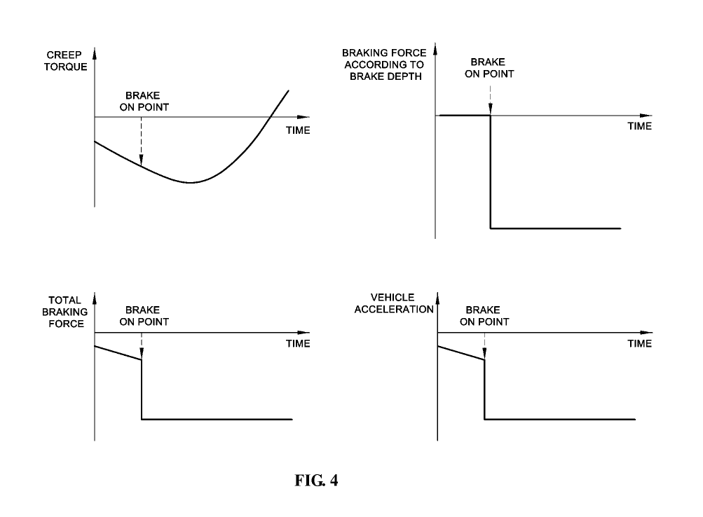

FIG. 4 shows the total braking force calculated by summing the frictional braking force based on the brake pedal depth and the creep torque at the point of braking. The total braking force may be calculated by adding the creep torque at the point of the input of the brake pedal depth to the demand frictional braking force based on the brake pedal depth after calculating the demand braking force based on the brake pedal depth. When the total braking force is calculated according to the substantially uniform brake depth, the braking force may be maintained at a substantially uniform value regardless of the vehicle speed.

As described above, to maintain a substantially uniform braking force, the present invention may include a method of measuring the creep torque set based on the vehicle speed at the point of the braking and summing the creep torque having a substantially uniform value to the braking force based on the brake pedal depth to calculate the total braking force. Additionally, since the total braking force may be applied based on a substantially uniform brake depth by a driver, the acceleration of a vehicle according to time may also be maintained at a substantially uniform value. Unlike the related art shown in FIG. 1, in which the total braking force varies based on the vehicle speed due to the creep torque varying based on the vehicle speed even when a substantially uniform brake depth is input, the present invention may provide substantially uniform total braking force and acceleration of a vehicle based on a substantially uniform brake depth, by adding a substantially uniform creep torque at the point of brake to the total braking force.

The present invention has an effect of providing a substantially uniform braking force based on the vehicle speed by including a creep torque at the point of braking in the calculation of the total braking force based on the input point of the brake pedal and distribution of the total braking force to each braking unit. Further, since a more uniform braking force may be applied according to the vehicle speed, a feeling of being pushed (e.g., a jerk feeling) by a motor torque before a stop may not be caused. Accordingly, when a vehicle driver performs a braking operation, the brake riding comfort may be improved. In addition, since the creep torque may be calculated by adding the creep torque at the point of braking, the fuel efficiency may be improved upon braking . . . .

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for controlling a distribution of a braking force of a vehicle, comprising:
measuring, by a controller, a creep torque at a point of braking;
calculating, by the controller, a total braking force by summing the measured creep torque and a braking force generated based on a brake pedal depth while fixing the measured creep torque; and
distributing, by the controller, the total braking force to a regenerative braking force and a frictional braking force.

2. The method of claim 1, wherein the distributing of the total braking force further comprises:
determining, by the controller, whether a brake input signal is complete after the distribution of the total braking force; and
stopping, by the controller, braking and setting a creep torque based on a current vehicle speed when the brake input signal is complete, and measuring the creep torque at the point of braking when the brake input signal is not complete.

3. The method of claim 1, wherein the calculation of the total braking force includes:
maintaining, by the controller, the total braking force at a substantially uniform value upon performance of braking by summing the braking force generated based on the brake pedal depth and the measured creep torque.

4. An apparatus for controlling a distribution of a braking force of a vehicle, comprising:
a sensor configured to detect a brake input signal and measure a brake pedal depth; and
a controller configured to:
calculate a total braking force by adding a creep torque measured at a point of braking to a braking force based on the brake pedal depth while fixing the measured creep torque; and
distribute the total braking force to a regenerative braking force and a frictional braking force.

5. The apparatus of claim 4, wherein the calculated total braking force of the braking units is calculated by summing a substantially uniform braking force generated based on the brake pedal depth and the measured creep torque, and has a substantially uniform value upon braking.

6. The apparatus of claim 4, wherein the controller includes a brake controller, a vehicle controller, a motor controller, and a transmission controller.

7. A non-transitory computer readable medium containing program instructions executed by a controller, the computer readable medium comprising:
program instructions that measure a creep torque at a point of braking;
program instructions that calculate a total braking force by summing the measured creep torque and a braking force generated based on a brake pedal depth while fixing the measured creep torque; and
program instructions that distribute the total braking force to a regenerative braking force and a frictional braking force.

8. The non-transitory computer readable medium of claim 7, further comprising:
program instructions that determine whether a brake input signal is complete after the distribution of the total braking force; and
program instructions that stop braking and set a creep torque based on a current vehicle speed when the brake input signal is complete, and measure the creep torque at the point of braking when the brake input signal is not complete.

9. The non-transitory computer readable medium of claim 7, further comprising:
program instructions that maintain the total braking force at a substantially uniform value upon performance of braking by summing the braking force generated based on the brake pedal depth and the measured creep torque.
